(19) United States
(12) Patent Application Publication
(10) Pub. No.: US 2009/0178553 A1
(43) Pub. Date: Jul. 16, 2009

(54) COMPRESSOR

(75) Inventor: Akira Haneda, Kanagawa (JP)

Correspondence Address: PEARNE & GORDON LLP, 1801 EAST 9TH STREET, SUITE 1200, CLEVELAND, OH, 44114-3108, US

(73) Assignee: MATSUSHITA ELECTRIC INDUSTRIAL CO., LTD., Osaka (JP)

(21) Appl. No.: 12/090,550

(22) PCT Filed: Sep. 14, 2007
(86) PCT No.: PCT/JP2007/068495

§ 371 Date: Apr. 17, 2008

(30) Foreign Application Priority Data
Sep. 27, 2006 (JP) 2006-262170

(51) Int. Cl. F15B 21/04

(52) U.S. Cl. 92/82

(57) ABSTRACT

The compressor of the present invention has a structure in which a groove is disposed on a sealing surface of at least one of the head and the valve plate. The structure enhances contact pressure on a pressed surface, providing the gasket with preferable sealing strength. Besides, the head of the compressor has no protrusion on the edge. This eliminates worry about breakage of the head, providing high reliability and productivity.

### TECHNICAL FIELD

The present invention relates to a compressor used for a refrigerator-freezer and the like.

### BACKGROUND ART

To achieve high efficiency, a conventional compressor has employed a method of reducing losses in operation, for example, with the use of an improved compression chamber capable of minimizing leakage of compressed refrigerant through the divided section between the inlet side and the outlet side of the chamber.

Japanese Patent Unexamined Publication No. 2000-154779 discloses a conventional compressor. Here will be described the compressor with reference to drawings.

FIG. 15 is a section view of a conventional compressor. FIG. 16 is an exploded view of the essential part of compression elements of the compressor. FIG. 17 shows an enlarged head as seen in the direction of N in FIG. 16. FIG. 18 is an enlarged sectional view of a protrusion taken along the plane of line P-P of FIG. 17. FIG. 19 is an enlarged sectional view showing the essential part of a valve plate, a gasket and a head.

In FIG. 15 through FIG. 19, enclosed container 1 accommodates electrical driving element 5 formed of stator 3 and rotator 4, and compression mechanism 6 driven by electrical driving element 5. Enclosed container 1 retains oil 2 in the bottom. Compression mechanism 6 is resiliently kept by spring 7. Enclosed container 1 is filled with refrigerant 8.

Next will be described the main structure of compression mechanism 6.

Block 9 forms generally cylindrical compression chamber 10, to which bearing section 11 is secured. Crank shaft 15, which has main shaft part 16 and eccentric shaft part 17, is journaled on bearing section 11. Rotator 4 is press-fitted with crank shaft 15. Piston 18 is inserted in compression chamber 10 so as to have a reciprocal sliding movement. Connecting rod 19 connects between eccentric shaft part 17 and piston 18.

Valve plate 12 is disposed at an opening end of block 9 so as to block the opening of compression chamber 10. Inlet reed 20 and gasket block 21 are sandwiched between valve plate 12 and the opening end of compression chamber 10. Valve plate 12 has discharge valve unit 12a. Head 13 forms delivery chamber 22 and covers discharge valve unit 12a. Gasket 23 for preventing leakage of refrigerant 8 is disposed between valve plate 12 and head 13.

Inlet muffler 14 is fixed to head 13, with one end of it in open communication with the inside of enclosed container 1 and the other end communicated with compression chamber 10.

Protrusion 25 is formed along the edge of head 13 by aluminum die-casting so as to encircle delivery chamber 22. Gasket 23 is made of packing material of rubber-coated paper.

Gasket block 21, inlet reed 20, valve plate 12, gasket 23 and head 13 are screw-threaded into block 9 with bolt 24.

Now will be described the workings of such structured conventional compressor.

Feeding electrically driving element 5 with electric power rotates rotator 4 and crank shaft 15. In the rotation, eccentric rotating movement of eccentric shaft part 17 is transmitted to piston 18 via connecting rod 19. Receiving the movement, piston 18 has a reciprocal movement in compression chamber 10. As piston 18 reciprocally moves, refrigerant 8 in enclosed container 1 is fed through inlet muffler 14 into compression chamber 10, and at the same time, refrigerant 8 under low pressure is fed from a refrigeration system (not shown) through an inlet pipe (also not shown) into enclosed container 1. After compressed in compression chamber 10, refrigerant 8 flows through discharge valve unit 12a of valve plate 12 into delivery chamber 22 in head 13. Delivered in delivery chamber 22, the high-pressure refrigerant gas goes through outlet pipe (not shown) back to the refrigeration system.

In the process above, discharge valve unit 12a effects open/close control of a delivery reed (not shown); opening the delivery reed establishes fluid communication via a delivery hole between compression chamber 10 and delivery chamber 22, and closing the delivery reed blocks the communication between the two chambers.

As bolt 24 tightens, protrusion 25 of head 13 is pressed against gasket 23. The tight engagement strengthens sealing, thereby minimizing leakage of the refrigerant 8. As a result, reduced amount of refrigerant leaked from delivery chamber 22 into enclosed container 1 contributes to improved volumetric efficiency of the compressor.

The conventional structure, however, has some inconveniences; if bolt 24 is screwed down with an excessive tightening torque, a strong force exerted locally on protrusion 25, breakage may result. Besides, the protruded structure of protrusion 25 has often damaged when accidentally bumped against something in the manufacturing process.

### SUMMARY OF THE INVENTION

The compressor of the present invention has a block that forms a compression chamber; a valve plate having a discharge valve unit that seals an opening of the compression chamber; a head that forms a delivery space surrounding the discharge valve unit, the head pressed against the valve plate; and a gasket that is kept between the valve plate and the head so as to seal the delivery space. In the structure above, the gasket has a decreased sealing width in a manner that a groove is formed at a section with which the gasket makes a contact of at least one of the head and the valve plate.

The structure having a groove formed in a sealing surface of at least one of the head and the valve plate eases shearing force on the sealing surface. This enhances contact pressure of the pressed surface, maintaining sealing efficiency of the gasket in a good condition. At the same time, the structure of the head without a protrusion makes it less prone to breakages.

### BRIEF DESCRIPTION OF THE DRAWINGS

FIG. 1 is a sectional view of a compressor in accordance with a first exemplary embodiment of the present invention.

FIG. 2 is an exploded view of compression elements of the compressor.

FIG. 3 is an enlarged view of a head as seen in the direction of A of FIG. 2.

FIG. 4 is an enlarged sectional view of a groove taken along the plane of line C-C of the head of FIG. 3.

FIG. 5 is an enlarged view of a gasket as seen in the direction of A of FIG. 2.

FIG. 6 is an enlarged view of a valve plate as seen in the direction of B of FIG. 2.

FIG. 7 is an enlarged view of the gasket showing the area that undergoes contact pressure as seen in the direction of A of FIG. 2.

FIG. 8 is an enlarged sectional view showing the essential part of the valve plate, the gasket and the head that have been tightened together with a bolt.

FIG. 9 is an enlarged view of a valve plate as seen from the side of a head of a compressor in accordance with a second exemplary embodiment.

FIG. 10 is an enlarged sectional view of a groove taken along the plane of line J-J of the valve plate of FIG. 9.

FIG. 11 is an enlarged view of a gasket as seen from the side of the head of the compressor in accordance with the second exemplary embodiment.

FIG. 12 is an enlarged view of the head as seen from the side of the valve plate of the compressor.

FIG. 13 is an enlarged view of the gasket showing the area that undergoes contact pressure as seen from the side of the valve plate of the compressor.

FIG. 14 is an enlarged sectional view showing the essential part of the valve plate, the gasket and the head that have been tightened together with a bolt.

FIG. 15 is a sectional view of a conventional compressor.

FIG. 16 is an exploded view of compression elements of a conventional compressor.

FIG. 17 is an enlarged view of a head as seen in the direction of N of FIG. 16.

FIG. 18 is an enlarged sectional view of a protrusion taken along the plane of line P-P of FIG. 17.

FIG. 19 is an enlarged sectional view showing the essential part of a valve plate, a gasket and a head of a conventional compressor.

### DETAILED DESCRIPTION OF THE PREFERRED EMBODIMENTS

The exemplary embodiments of the present invention are described hereinafter with reference to the accompanying drawings.

### First Exemplary Embodiment

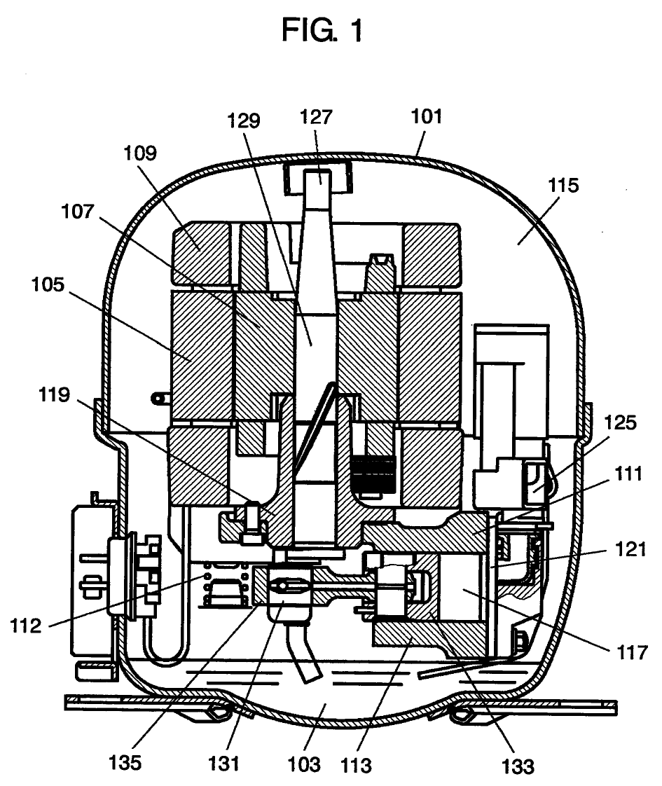

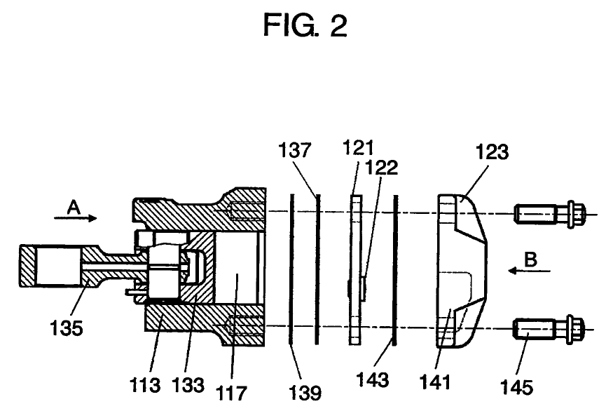

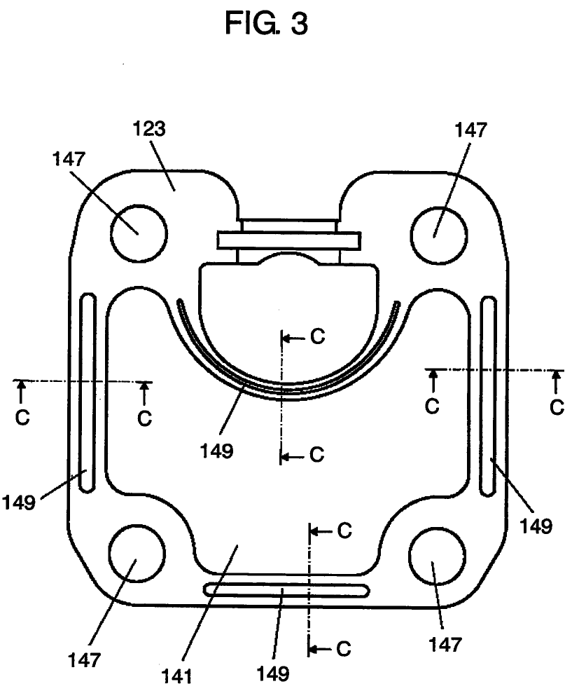

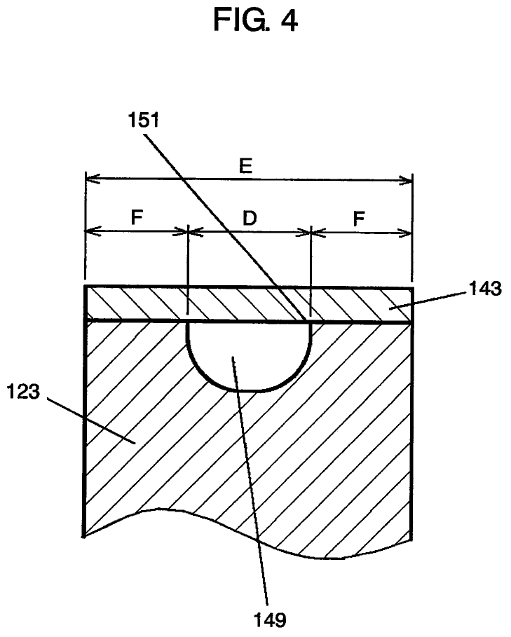

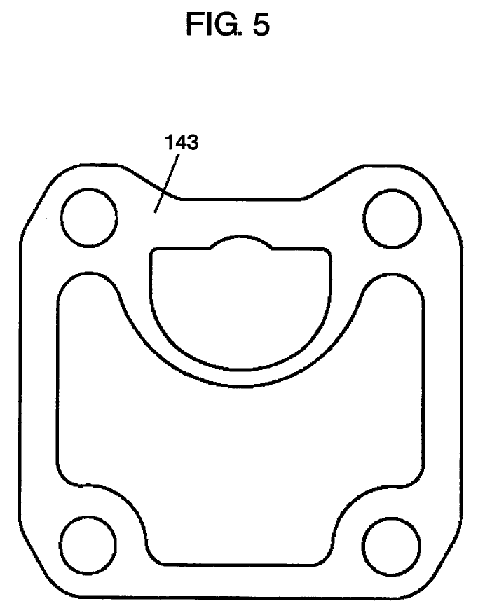

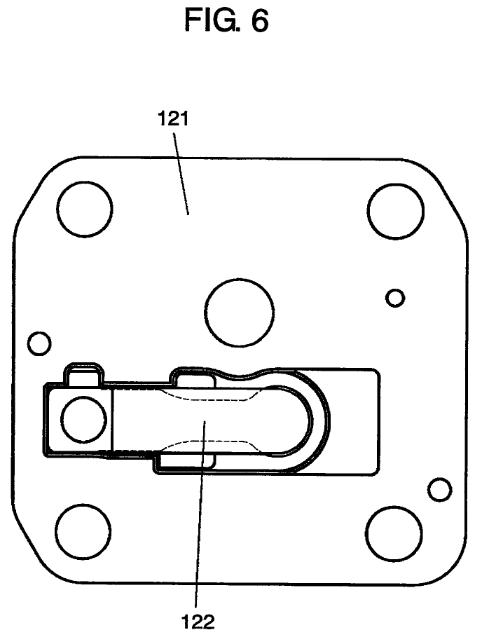

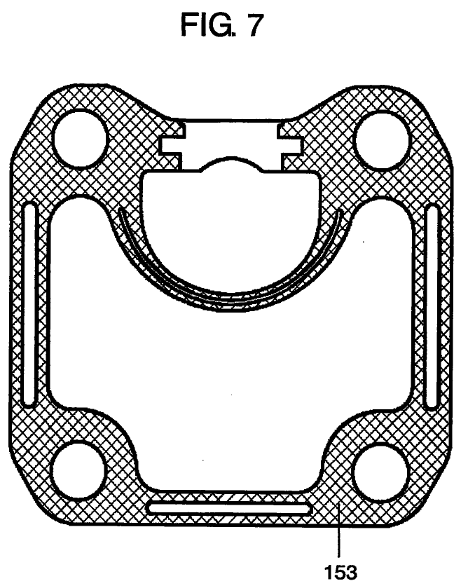

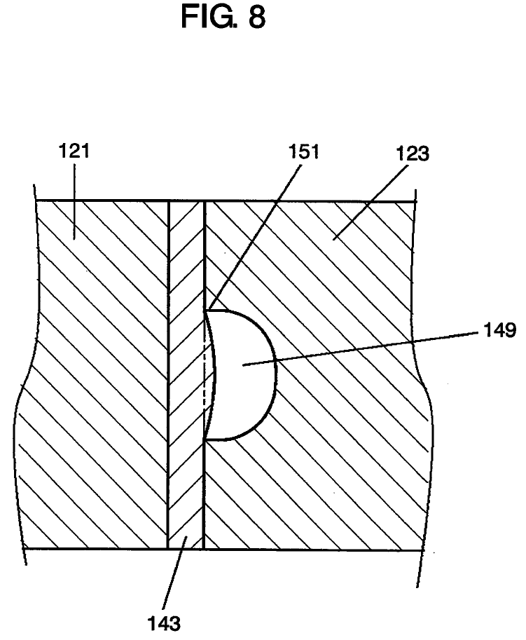

FIG. 1 is a sectional view of a compressor in accordance with the first exemplary embodiment of the present invention. FIG. 2 is an exploded view of compression elements of the compressor. FIG. 3 is an enlarged view of a head as seen in the direction of A of FIG. 2. FIG. 4 is an enlarged sectional view of a groove taken along the plane of line C-C of the head of FIG. 3. FIG. 5 is an enlarged view of a gasket as seen in the direction of A of FIG. 2. FIG. 6 is an enlarged view of a valve plate as seen in the direction of B of FIG. 2. FIG. 7 is an enlarged view of the gasket showing the area that undergoes contact pressure as seen in the direction of A of FIG. 2. FIG. 8 is an enlarged sectional view showing the essential part of the valve plate, the gasket and the head that have been tightened together with a bolt.

In FIG. 1 through FIG. 8, enclosed container 101 accommodates electrical driving element 109 formed of stator 105 and rotator 107, and compression mechanism 111 driven by electrical driving element 109. Enclosed container 101 retains oil 103 in the bottom. Compression mechanism 111 is resiliently kept by spring 112. Enclosed container 101 is filled with refrigerant 115.

Next will be described the main structure of compression mechanism 111.

Block 113 forms generally cylindrical compression chamber 117, to which bearing section 119 is secured. Crank shaft 127, which has main shaft part 129 and eccentric shaft part 131, is journaled on bearing section 119. Rotator 107 is press-fitted with crank shaft 127. Piston 133 is inserted in compression chamber 117 so as to have a reciprocal sliding movement. Connecting rod 135 connect between eccentric shaft part 131 and piston 133.

Valve plate 121 is disposed at an opening end of block 113 so as to block the opening of compression chamber 117. Inlet reed 137 and gasket block 139 are sandwiched between valve plate 121 and the opening end of compression chamber 117. Gasket block 139 prevents leakage of refrigerant gas from the opening end of compression chamber 117 and inlet reed 137.

Discharge valve unit 122 is disposed on a surface opposite to the surface facing block 113 of valve plate 121.

Head 123 is disposed on the side opposite to block 113 via valve plate 121. Head 123 forms delivery chamber 141 as a delivery space and covers discharge valve unit 122.

Gasket 143 for preventing leakage of refrigerant 115 is disposed between valve plate 121 and head 123. Gasket 143 is made of packing material of rubber-coated paper.

Inlet muffler 125 is fixed to head 123, with one end of it in open communication with the inside of enclosed container 101 and the other end communicated with compression chamber 117.

Head 123, which is formed by aluminum die-casting, has bolt hole 147 for bolt 145 in the four corners. Groove 149 is formed close to an edge of head 123 so as to meet with gasket 143 at a distance from bolt hole 147. Groove 149 at an edge of head 123, as shown in FIG. 4, forms edge section 151 without shear drop. Forming groove 149 by cutting or forming groove 149 by aluminum die-casting and then cutting the edges of head 123 allows edge section 151 to have an edge without shear drop.

Groove 149 of the embodiment is, as shown in FIG. 4, positioned in width E of gasket 143. Groove 149 has width D that measures about one-third the length of sealing width E of head 123 and sealing width F measures about one-third the length of sealing width E.

The sealing width mentioned above means the width used for sealing, such as width E of FIG. 4. Groove 149 is formed so as to have a width smaller than the sealing width of gasket 143.

Gasket block 139, inlet reed 137, valve plate 121, gasket 143 and head 123 a screw-threaded into block 113 with bolt 145.

The tightening force of bolt 145 pushes head 123 on gasket 143. Cross-hatched area 153 in FIG. 7 undergoes contact pressure, by which the structure above is sealed. In FIG. 7, the area corresponding to groove 149 disposed in head 123 has no contact pressure.

Now will be described the workings of such structured compressor of the embodiment.

Feeding electrical driving element 109 with electric power rotates rotator 107 and crank shaft 127. In the rotation, eccentric rotating movement of eccentric shaft part 131 is transmitted to piston 133 via connecting rod 135. Receiving the movement, piston 133 has a reciprocal movement in compression chamber 117. As piston 133 reciprocally moves, refrigerant 115 in enclosed container 101 is fed through inlet muffler 125 into compression chamber 117, and at the same time, refrigerant 115 under low pressure is fed from a refrigeration system (not shown) through an inlet pipe (also not shown) into enclosed container 101. After compressed in compression chamber 117, refrigerant 115 flows through discharge valve unit 122 of valve plate 121 into delivery chamber 141 in head 123. Delivered in delivery chamber 141, the high-pressure refrigerant gas goes through outlet pipe (not shown) back to the refrigeration system.

In the process above, discharge valve unit 122 effects open/close control of delivery reed (not shown); opening the delivery reed establishes fluid communication via a delivery hole between compression chamber 117 and delivery chamber 141, and closing the delivery reed blocks the communication between the two chambers.

As bolt 145 tightens, head 123 is pressed against gasket 143 by the tightening force of bolt 145. Groove 149 disposed at the edge of head 123 substantially decreases the sealing width of gasket 143, which increases the contact pressure on gasket 143. Besides, the widthwise strength of gasket 143 is adequately maintained because the width of gasket 143 has no change in dimension. The sufficient strength protects gasket 143 from damage caused by difference in pressure between delivery chamber 141 and enclosed container 101. In addition, increased contact pressure on gasket 143 enhances sealing strength of gasket 143.

Besides, head 123 has no need to have a protrusion that is disposed in the structure introduced in background art, eliminating the worry about damage on the protrusion caused by an accidental bump with other components.

Although the tightening force of bolt 145, i.e., contact pressure on gasket 143 strongly exerts on an area near bolt hole 147, the strength weakens with distance from bolt hole 147. According to the structure in the embodiment, groove 149 is formed at a location some distance from bolt hole 147. That is, the structure effectively increases the contact pressure on an area where the tightening force of bolt 145 on gasket 143 is weak.

In the structure of the embodiment, groove 149 has width D that measures about one-third the length of sealing width E of head 123. The substantial sealing width measures two-thirds of sealing width E, and accordingly, the contact pressure on gasket 143 achieves one-and-a-half times greater. Such a high sealing strength decreases a leakage amount of refrigerant from delivery chamber 141 to enclosed container 101, enhancing volumetric efficiency of the compressor.

Besides, groove 149 at an edge of head 123, as shown in FIG. 4, forms edge section 151 without shear drop. The tightening force of bolt 145 strongly pushes edge section 151 against gasket 143, enhancing an intimate connection between them as shown in FIG. 8. As a result, a sealing strength is further increased.

In the structure of the embodiment, groove 149 is positioned in width E of gasket 143; edge section 151 is formed in two places at a same section. The structure further enhances the sealing strength.

Forming groove 149 of head 123 by aluminum die-casting further enhances high productivity.

According to the structure of the embodiment, as described above, head 123 has no protrusion on the edge. This eliminates worry about breakage, providing high reliability and easy handling of head 123. At the same time, the simple structure with no protrusion promotes easy and effective manufacturing. Such structured compressor with the advantages above provides preferable sealing strength of gasket 143 and high efficiency in operation, with leakage of refrigerant 115 minimized.

### Second Exemplary Embodiment

The compressor of the second exemplary embodiment differs from the structure of the first exemplary embodiment in that a groove is formed in the valve plate, not in the head. As the rest of the structure is the same as that of the previous embodiment, the description will be focused on the difference above.

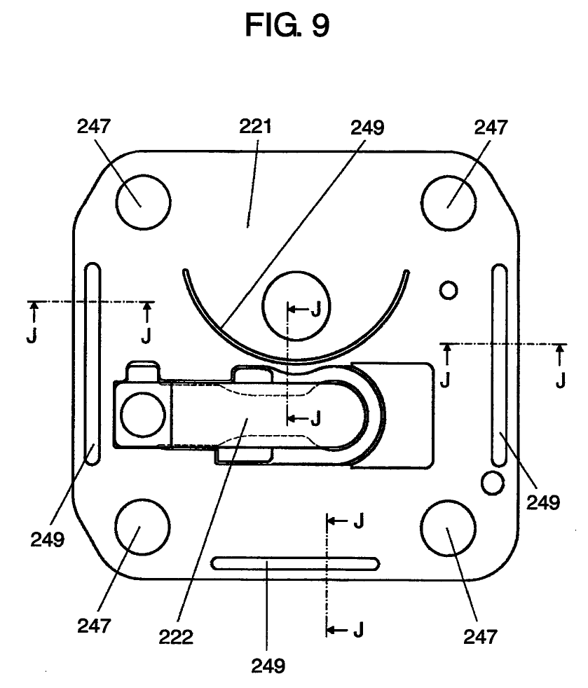

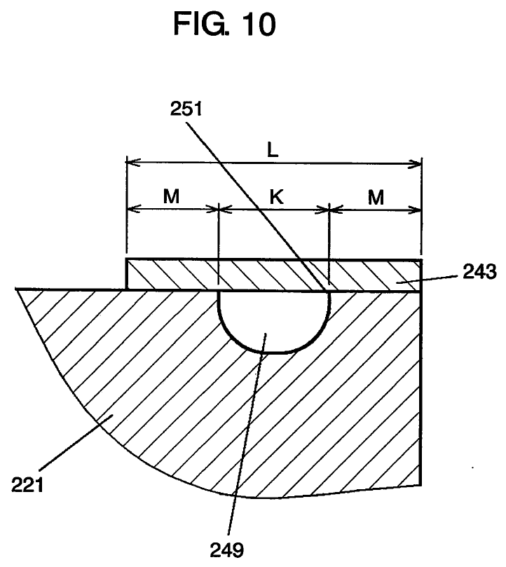

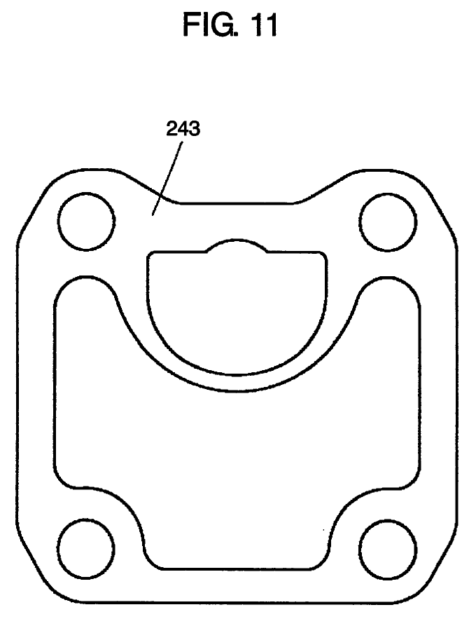

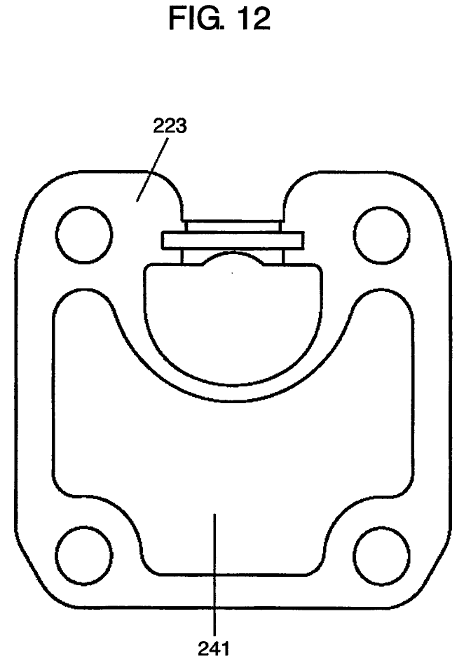

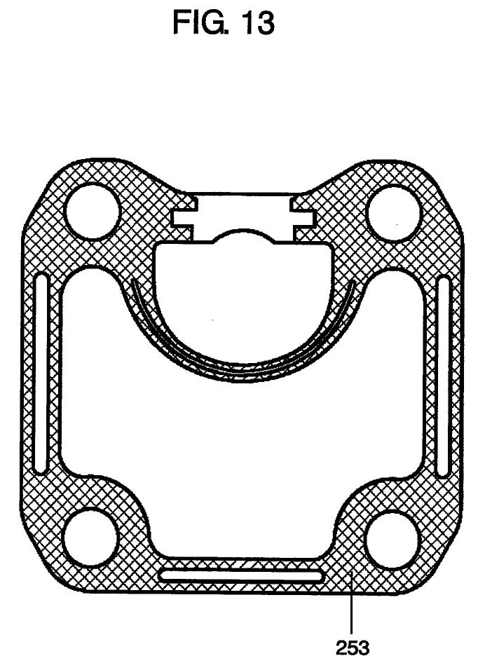

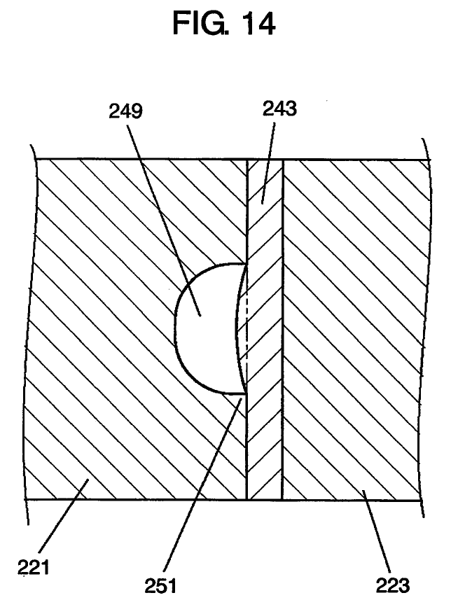

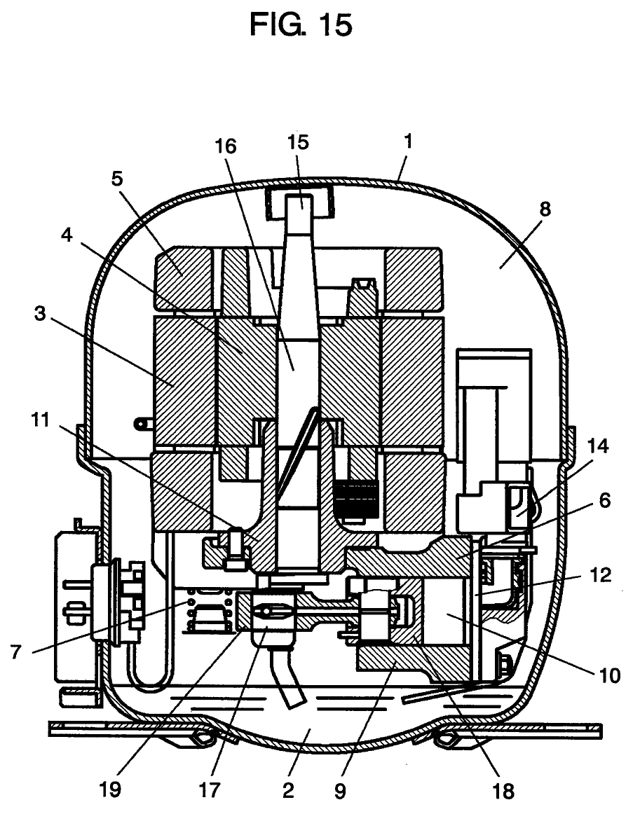

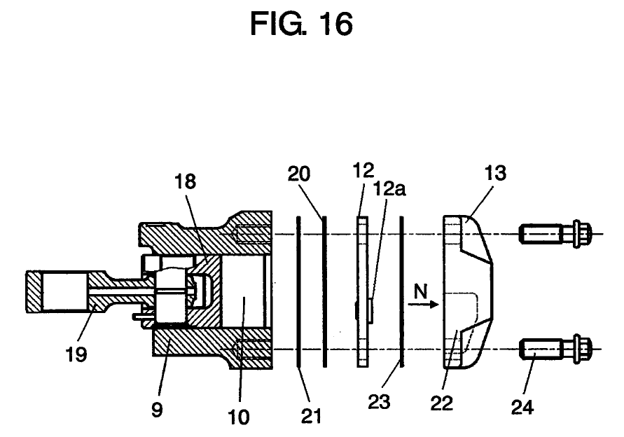

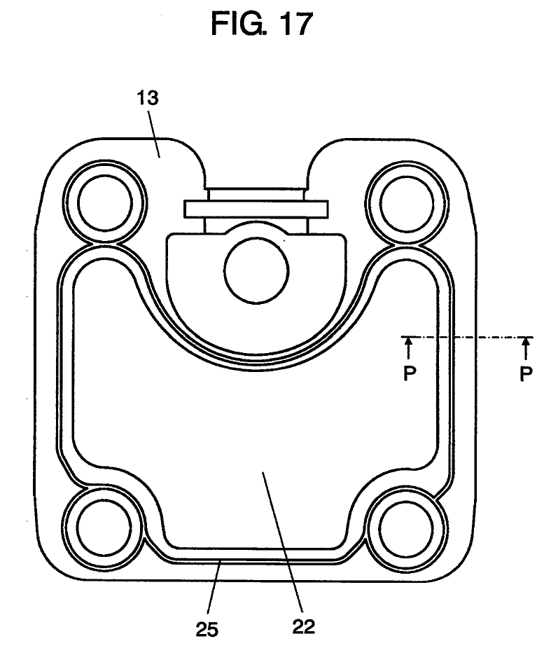

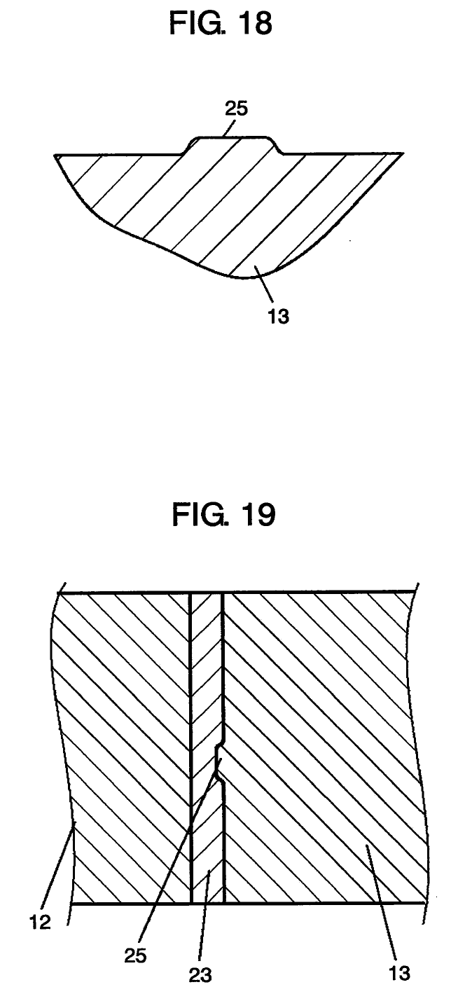

FIG. 9 is an enlarged view of a valve plate as seen from the side of a head of a compressor of the embodiment. FIG. 10 is an enlarged sectional view of a groove taken along the plane of line J-J of the valve plate of FIG. 9. FIG. 11 is an enlarged view of a gasket as seen from the side of the head of the compressor. FIG. 12 is an enlarged view of the head as seen from the side of the valve plate of the compressor. FIG. 13 is an enlarged view of the gasket showing the area that undergoes contact pressure as seen from the side of the valve plate of the compressor. FIG. 14 is an enlarged sectional view showing the essential part of the valve plate, the gasket and the head that have been tightened together with a bolt.

Valve plate 221, which is made of sintered metal, has discharge valve unit 222 thereon, as is in the valve plate described in the first exemplary embodiment. Groove 249 is formed close to an edge of valve plate 221 at a distance from bolt hole 247. Groove 249 at an edge of valve plate 221, as shown in FIG. 10, forms edge section 251 without shear drop. Cutting the edges of valve plate 221 removes shear drop between the edge and groove 249, allowing edge section 251 to have an edge with precise dimensions.

Groove 249 of the embodiment is, as shown in FIG. 10, positioned in width L of valve plate 221. Groove 249 has width K that measures about one-third the length of sealing width M of valve plate 221 and sealing width M measures about one-third the length of sealing width L.

Tightening force of a bolt pushes head 223 on gasket 243. Cross-hatched area 253 in FIG. 13 undergoes contact pressure, by which the structure above is sealed. The area that meets with groove 249 is free from the contact pressure.

As a bolt tightens, head 223 is pressed against gasket 243 by the tightening force of the bolt. Groove 249 disposed at the edge of valve plate 221 substantially decreases the sealing width of gasket 243, which increases the contact pressure on gasket 243.

Besides, the widthwise strength of gasket 243 is adequately maintained because the width of gasket 243 has no change in dimension. The sufficient strength protects gasket 243 from damage caused by difference in pressure between delivery chamber 241 and enclosed container 101. In addition, increased contact pressure on gasket 243 enhances sealing strength of gasket 243.

Besides, head 223 has no need to have a protrusion that is disposed in the structure introduced in background art, eliminating the worry about damage on the protrusion caused by an accidental bump with other components.

Although the tightening force of the bolt, i.e., contact pressure on gasket 243 strongly exerts on an area near bolt hole 247, the strength weakens with distance from bolt hole 247. According to the structure in the embodiment, groove 249 is formed at a location some distance from bolt hole 247. That is, the structure effectively increases the contact pressure on an area where the tightening force of bolt on gasket 243 is weak.

In the structure of the embodiment, groove 249 has width K that measures about one-third the length of sealing width L of head 223. The substantial sealing width measures two-thirds of sealing width L, and accordingly, the contact pressure on gasket 243 achieves one-and-a-half times greater. Such a high sealing strength decreases a leakage amount of refrigerant from delivery chamber 241 to enclosed container 101, enhancing volumeric efficiency of the compressor.

Besides, groove 249 at an edge of valve plate 221, as shown in FIG. 10, forms edge section 251 without shear drop. The tightening force of the bolt strongly pushes edge section 251 against gasket 243, enhancing an intimate connection between them as shown in FIG. 14. As a result, a sealing strength is further increased.

In the structure of the embodiment, groove 249 is positioned in width L of gasket 243; edge section 251 is formed in two places at a same section. The structure further enhances the sealing strength.

Groove 249 of valve plate 221 is made of sintered metal. This provides high productivity.

According to the structure of the embodiment, as described above, head 223 has no protrusion on the edge. This eliminates worry about breakage, providing high reliability and easy handling of head 223. At the same time, the simple structure with no protrusion promotes easy and effective manufacturing. Such structured compressor with the advantages above provides preferable sealing strength of gasket 243 and high efficiency in operation, with leakage of refrigerant 115 minimized.

### INDUSTRIAL APPLICABILITY

The compressor of the present invention, as described above, has an improved gasket having preferable sealing strength and therefore decreases operation failure caused by leakage of refrigerant. This provides the compressor with high reliability. Besides, simply structured head contributes to cost-reduced manufacturing. The compressor is fit for a wide range of uses: refrigerators intended for home use, dehumidifiers, refrigeration showcases used in stores, restaurants and the like, vending machines and other apparatuses that employ a refrigeration cycle.

1. A compressor comprising:
a block that forms a compression chamber;
a valve plate that seals an opening of the compression chamber, the valve plate on which a discharge valve unit is formed;
a head that forms a delivery space surrounding the discharge valve unit, the head pressed against the valve plate; and
a gasket that is kept between the valve plate and the head so as to seal the delivery space,
wherein, the gasket has a decreased sealing width in a manner that a groove is formed at a section with which the gasket makes a contact of at least one of the head and the valve plate.

2. The compressor of claim 1, wherein the groove has a width smaller than the sealing width of the gasket.

3. The compressor of claim 1, wherein the valve plate, the gasket and the head are screw-threaded through the block with a bolt, and the groove is formed at a location with a distance from the bolt-secured position.

4. The compressor of claim 1, wherein the head is formed by aluminum die-casting, and the groove is formed by die-cast molding.

5. The compressor of claim 1, wherein the valve plate is formed of sintered metal, and the groove is formed by sintered mold.
